(19) United States
(12) Patent Application Publication
(10) Pub. No.: US 2007/0201232 A1
(43) Pub. Date: Aug. 30, 2007

(54) Illumination apparatus having heat dissipating capability

(76) Inventor: Kuei-Fang Chen, Hsinchu (TW)

Correspondence Address: CHRISTIE, PARKER & HALE, LLP, PO BOX 7068, PASADENA, CA, 91109-7068, US

(21) Appl. No.: 11/478,398

(22) Filed: Jun. 28, 2006

(30) Foreign Application Priority Data
Feb. 27, 2006 (TW) 095106590

(51) Int. Cl. F21V 29/00

(52) U.S. Cl. 362/294

(57) ABSTRACT

An illumination apparatus includes a heat sink having a circuit-mounting side provided with a heat-conductive insulating film thereon. A lighting device includes a printed circuit provided on the circuit-mounting side of the heat sink and in thermal contact with the heat-conductive insulating film, and a lighting unit having a light emitting diode that is in the form of a chip die, that is connected electrically and wiredly to the printed circuit and that is in thermal contact with the heat-conductive insulating film.

### CROSS-REFERENCE TO RELATED APPLICATION

This application claims priority of Taiwanese Application No. 095106590, filed on Feb. 27, 2006.

### BACKGROUND OF THE INVENTION

1. Field of the Invention

The invention relates to an illumination apparatus, more particularly to an illumination apparatus having heat dissipating capability.

2. Description of the Related Art

Generally, light emitting diodes have been widely used in an illumination apparatus. It is necessary for enhanced luminance to increase the number of light emitting diodes used in an illumination apparatus, thereby resulting in increased heat generated by the light emitting diodes. Thus, such an illumination apparatus is required to efficiently dissipate heat generated thereby.

Referring to FIGS. 1 and 2, a conventional illumination apparatus 10 is shown to include a heat sink 101, a circuit board 102, and a plurality of light emitting diodes 103. The circuit board 12 is attached fixedly on a mounting side 104 of the heat sink 101 using silicon adhesive (A). Each light emitting diode 103 is attached fixedly on the circuit board 102 using heat-conductive glue (B). In such a configuration, although the heat sink 101 is used for hear dissipation, the light emitting diodes 103 do not directly contact the heat sink 101 because of the circuit board 102, the silicon adhesive (A) and the heat-conductive glue (B) therebetween. As a result, heat generated by the light emitting diodes 103 cannot be effectively dissipated by the heat sink 101.

### SUMMARY OF THE INVENTION

The object of the present invention is to provide an illumination apparatus that has superior heat dissipating capability.

According to the present invention, an illumination apparatus comprises:
a heat sink having a circuit-mounting side provided with a heat-conductive insulating film thereon; and
a lighting device including
   a printed circuit provided on the circuit-mounting side of the heat sink and in thermal contact with the heat-conductive insulating film, and
   a lighting unit having a light emitting diode that is in the form of a chip die, that is connected electrically and wiredly to the printed circuit and that is in thermal contact with the heat-conductive insulating film.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional illumination apparatus;

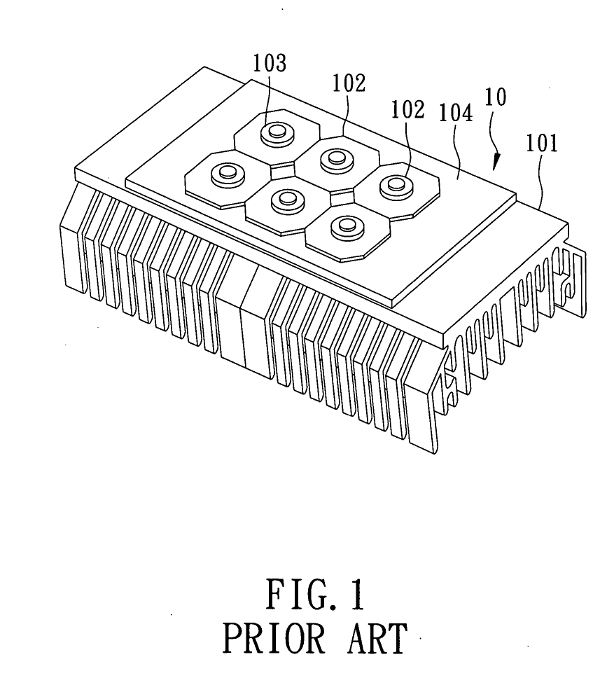

FIG. 2 is a schematic sectional view of the conventional illumination apparatus;

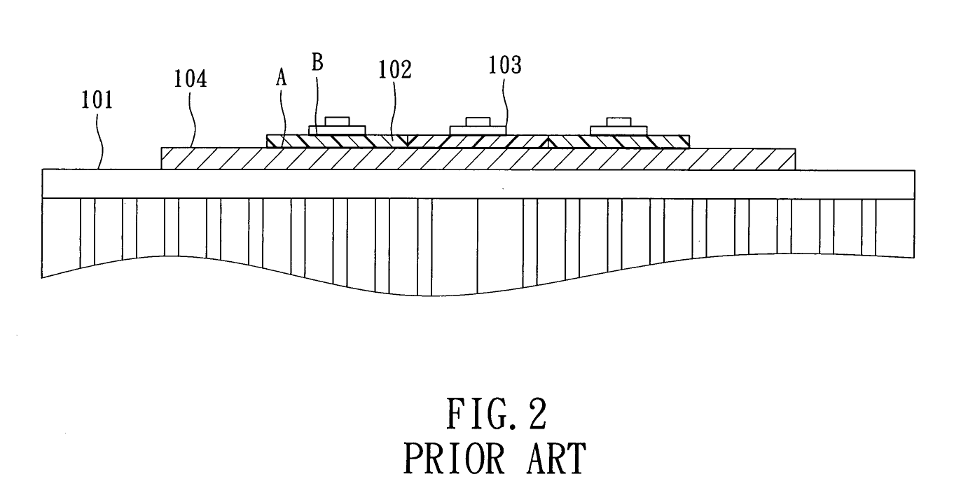

FIG. 3 is a partly exploded perspective view showing the first preferred embodiment of an illumination apparatus according to the present invention;

FIG. 4 is a fragmentary schematic sectional view of the first preferred embodiment;

FIG. 5 is a partly exploded perspective view showing the second preferred embodiment of an illumination apparatus according to the present invention;

FIG. 6 is a perspective view showing the third preferred embodiment of an illumination apparatus according to the present invention;

FIG. 7 is an exploded perspective view showing the fourth preferred embodiment of an illumination apparatus according to the present invention;

FIG. 8 is an assembled perspective view showing the fourth preferred embodiment;

FIG. 9 is a fragmentary schematic sectional view of the fourth preferred embodiment; and

FIG. 10 is a partly exploded perspective view showing the fifth preferred embodiment of an illumination apparatus according to the present invention.

### DETAILED DESCRIPTION OF THE PREFERRED EMBODIMENTS

Before the present invention is described in greater detail, it should be noted that like elements are denoted by the same reference numerals throughout the disclosure.

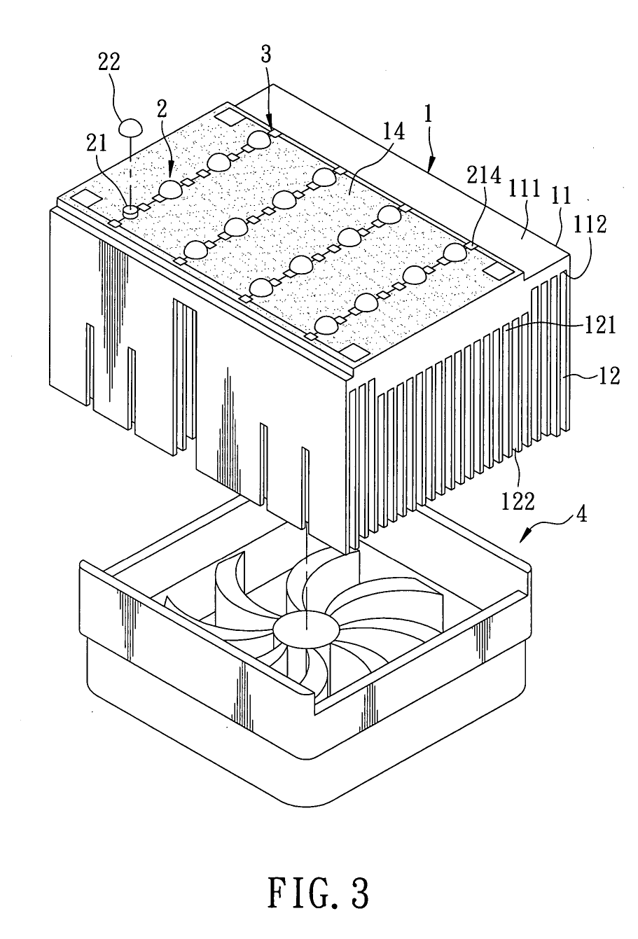

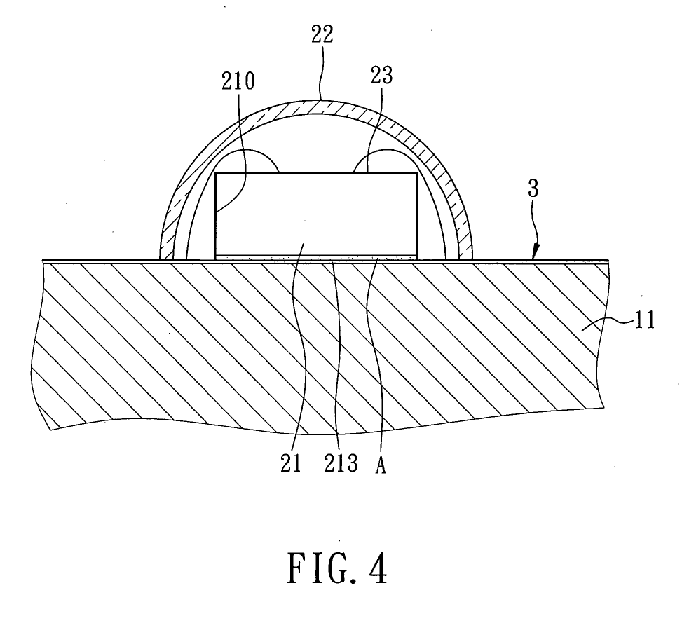

Referring to FIGS. 3 and 4, the first preferred embodiment of an illumination apparatus according to the present invention is shown to include a heat sink 1, a lighting device, and a heat-dissipating fan 4.

The heat sink 1 is made of a metal material, such as Cu, Al, Fe, Cu alloy, etc., and has a base plate 11 having opposite first and second surfaces 111, 112, and a plurality of parallel heat dissipating fins 12. The first surface 111 of the base plate 11 constitutes a circuit-mounting side. The heat dissipating fins 12 extend from the second surface 112 of the base plate 11. Each of the heat dissipating fins 12 has a first end 121 formed integrally with the base plate 11, and a second end 122 opposite to the first end 121. The first surface 111 of the base plate 11 of the heat sink 1, i.e., the circuit-mounting side, is provided with a heat-conductive insulating film 14, such as a diamond-like carbon (DLC) film or an anodic aluminum oxide film, thereon. It is noted that each of the heat dissipating fins 12 is provided with a boron nitride coating thereon by spraying.

In this embodiment, the lighting device includes a printed circuit 3, and a plurality of lighting units 2. The printed circuit 3 is provided on the first surface 111 of the base plate 11 of the heat sink 1, and is in thermal contact with the heat-conductive insulating film 14. The lighting units 2 are arranged in an array. Each of the lighting units 2 has a light emitting diode 21 and a transparent cover member 22. The light emitting diode 21 is in the form of a chip die, is attached on the first surface 111 of the base plate 11 of the heat sink 1 using a heat-conductive glue (A), such as a silver glue, and is in thermal contact with the heat-conductive insulating film 14. It is noted that the light emitting diode 21 of each lighting unit 2 is connected electrically and wiredly to the printed circuit 3 by wire bonding, and has an outer surface 210 coated with a fluorescence layer 23. The transparent cover member 22 is mounted fixedly on the first surface 111 of the base plate 11 of the heat sink 1 using a silicon glue, and covers the light emitting diode 21. In this embodiment, the transparent cover member 22 of each lighting unit 2 includes a hollow hemispherical cover, and is made of a transparent plastic material added with a component selected from a group of (OCH₃)₂(C₆H₄)₂(CHCHC₆H₄)₂, C₆H₄NOCC₁₀H₆CONH₄C₆ and C₆H₅CHCHC₆H₅ for improving luminance of the lighting device.

The heat dissipating fan 4 is mounted on the second ends 122 of the heat dissipating fins 12 of the heat sink 1.

It is noted that, due to the presence of the boron nitride coating, an effective total heat dissipating area of the heat sink 1 can be increased to at least 150 times that without the boron nitride coating, thereby making a temperature drop of about 3° C. to 8° C. Therefore, the heat dissipating efficiency of the heat sink 1 can be enhanced by about 10%. Furthermore, due to the presence of the heat-conductive insulating film 14, the illumination apparatus of this invention can provide superior heat dissipating capability.

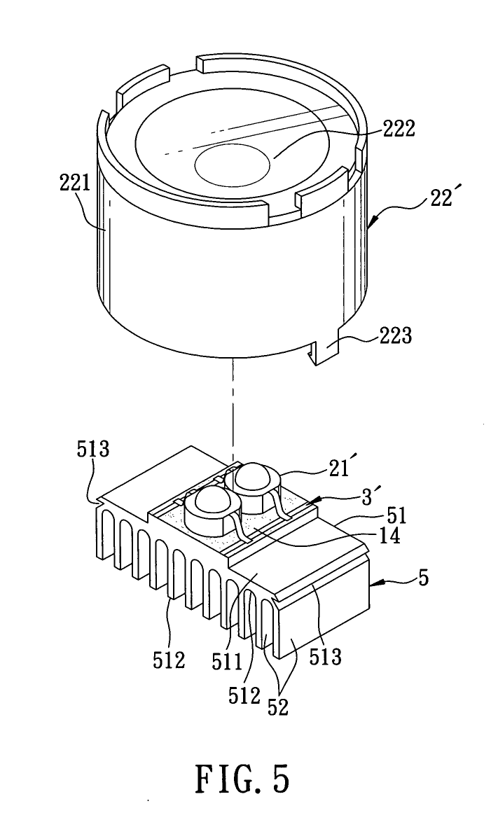

FIG. 5 illustrates the second preferred embodiment of an illumination apparatus according to this invention, which is a modification of the first preferred embodiment. In this embodiment, the heat sink 5 can be formed by aluminum-extrusion molding or can be made of copper or ceramic. The heat sink 5 has a base plate 51 having opposite first and second surfaces 511, 512, and a plurality of parallel heat dissipating fins 52. The first surface 511 of the base plate 51 serves as the circuit-mounting side, which is provided with the heat-conductive insulating film 14 thereon. The heat dissipating fins 52 extend from the second surface 512 of the base plate 51. The base plate 51 has opposite end surfaces, each of which is formed with an engaging groove 513. In this embodiment, the lighting device includes only one lighting unit, and the printed circuit 3′. The lighting unit has two light emitting diodes 21′, and the transparent cover member 22′ mounted on the first surface 511 of the base plate 51 of the first heat sink 5, i.e., the circuit-mounting side, and covering the light emitting diodes 21′. The transparent cover member 22′ shown in FIG. 5 differs from the transparent cover member 20 shown in FIG. 3 in that the transparent cover member 20′ includes a hollow lens-mounting seat 221 mounted fixedly on the circuit-mounting side of the heat sink 5 and disposed around the light emitting diodes 21′, and a condensing lens 222 mounted on the lens-mounting seat 221 and cooperating with the lens-mounting seat 221 so as to cover the light emitting diodes 21′ for condensing light generated thereby. The lens-mounting seat 221 is formed with opposite engaging hooks 223 that engage respectively the engaging grooves 513 in the end surfaces of the base plate 51 of the heat sink 5.

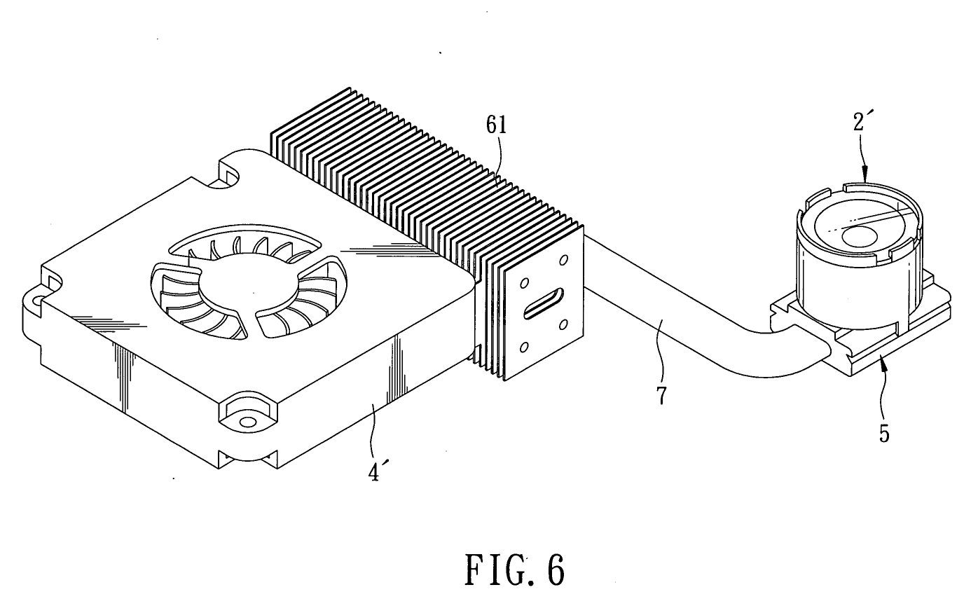

FIG. 6 illustrates the third preferred embodiment of an illumination apparatus according to this invention, which is a modification of the second preferred embodiment. Unlike the second preferred embodiment, the illumination apparatus further includes an additional heat sink 61 spaced apart from the heat sink 5, a heat exchanger pipe 7 that has opposite end portions connected heat-conductively and respectively to the heat sinks 5, 61, and an additional heat dissipating fan 4′ mounted on the heat sink 61. The heat sinks 5, 61, the heat exchanger pipe 7 and the heat dissipating fan 4′ are arranged in a horizontal direction.

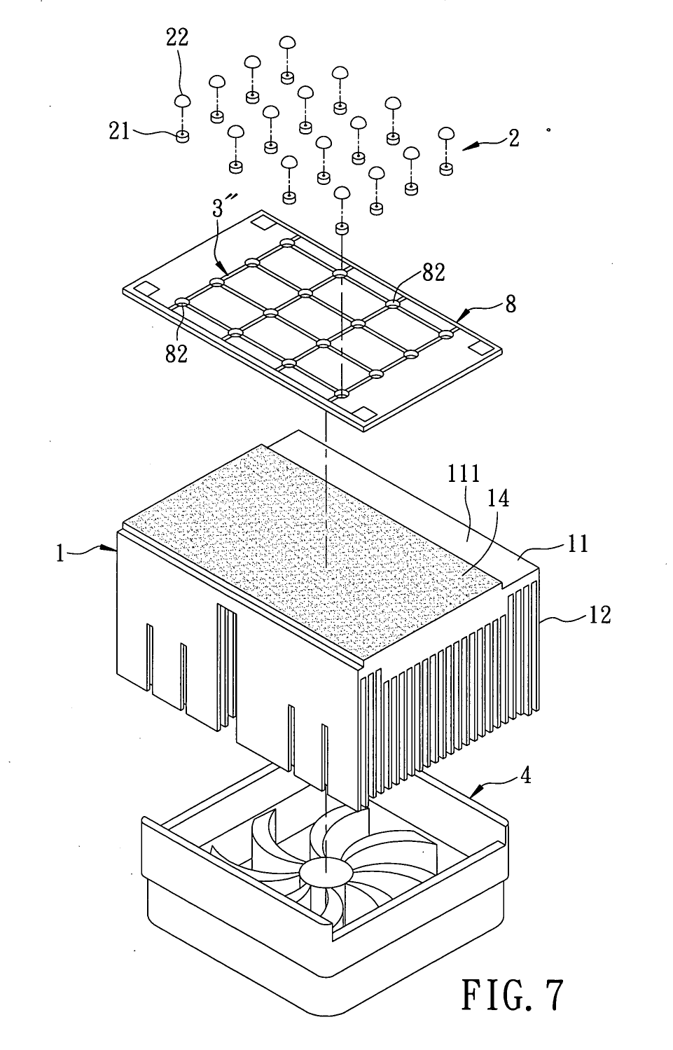

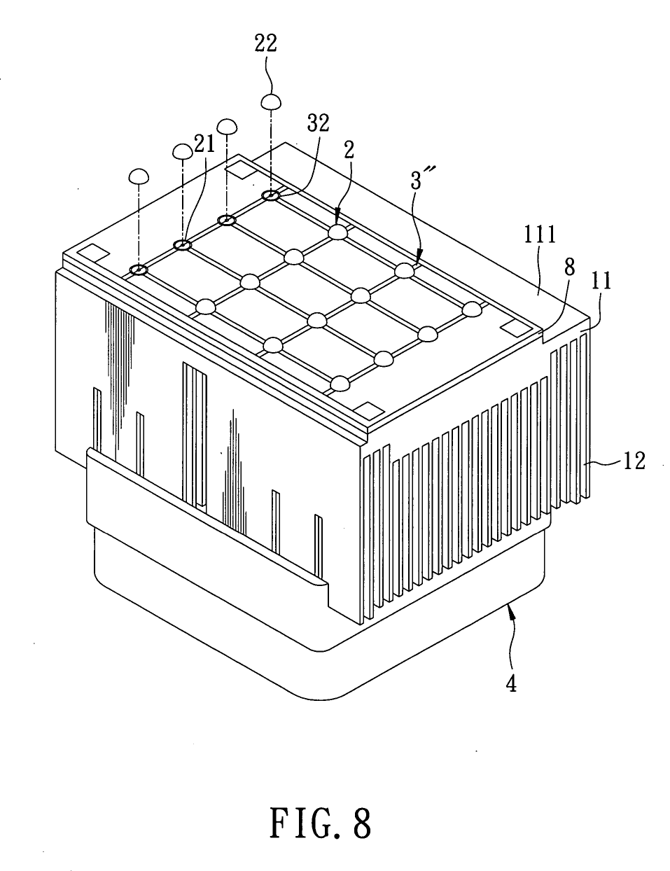

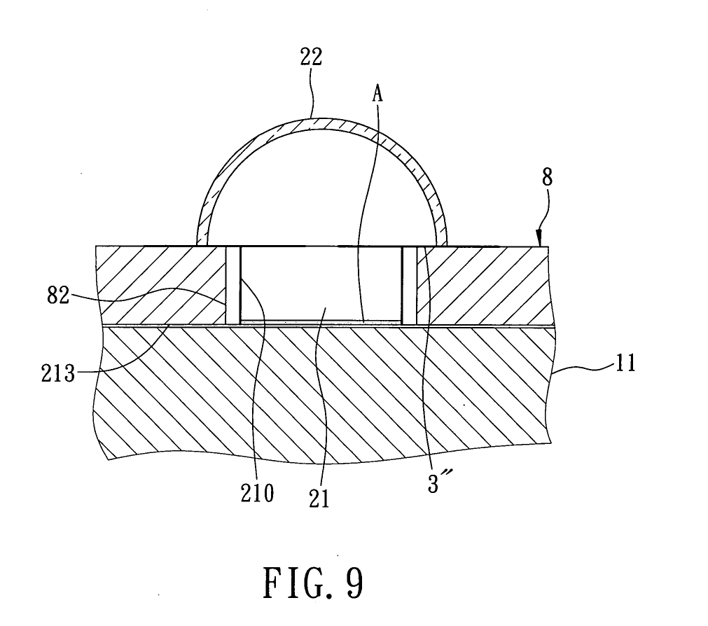

Referring to FIGS. 7 to 9, the fourth preferred embodiment of an illumination apparatus according to this invention, which is a modification of the first preferred embodiment. Unlike the first preferred embodiment, the illumination apparatus further includes a circuit board 8 disposed fixedly on the first surface 111 of the base plate 11 of the heat sink 1 using a silicon glue and provided with the printed circuit 3″ thereon. It is noted that the circuit board 8 is formed with a plurality of through holes 82 for receiving respectively the light emitting diodes 21 of the lighting units 2 therein such that the light emitting diodes 21 of the lighting units 2 are attached directly on the heat-conductive insulating film 14.

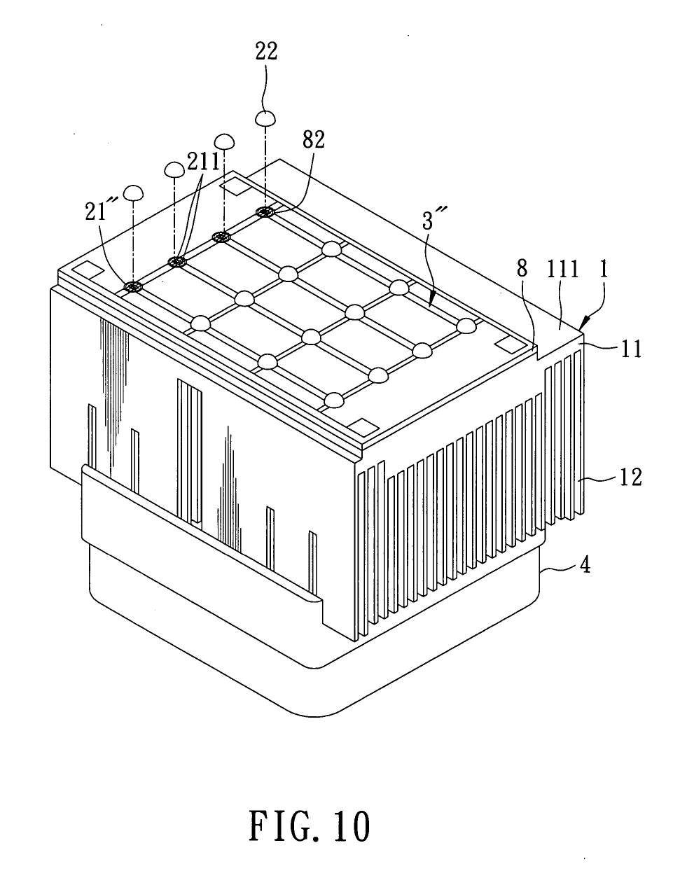

Referring to FIG. 10, the fifth preferred embodiment of an illumination apparatus according to this invention, which is a modification of the fourth preferred embodiment. In this embodiment, the light emitting diode 21″ of each lighting unit of the lighting device is formed with two lampwicks 211, thereby increasing illumination of the illumination apparatus.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An illumination apparatus comprising:
a heat sink having a circuit-mounting side provided with a heat-conductive insulating film thereon; and
a lighting device including
a printed circuit provided on said circuit-mounting side of said heat sink and in thermal contact with said heat-conductive insulating film, and
a lighting unit having a light emitting diode that is in the form of a chip die, that is connected electrically and wiredly to said printed circuit and that is in thermal contact with said heat-conductive insulating film.

2. The illumination apparatus as claimed in claim 1, wherein said heat-conductive insulating film is a diamond-like carbon film.

3. The illumination apparatus as claimed in claim 1, wherein said heat-conductive insulating film is an anodic aluminum oxide film.

4. The illumination apparatus as claimed in claim 1, wherein said heat sink includes a base plate that has a first surface serving as said circuit-mounting side, and a second surface opposite to said first surface, and a plurality of parallel heat dissipating fins extending from said second surface of said base plate.

5. The illumination apparatus as claimed in claim 4, wherein each of said heat dissipating fins has a first end formed integrally with said base plate, and a second end opposite to said first end, said illumination apparatus further comprising a heat dissipating fan mounted on said second ends of said heat dissipating fins of said heat sink.

6. The illumination apparatus as claimed in claim 4, wherein each of said heat dissipating fins of said heat sink is provided with a boron nitride coating thereon.

7. The illumination apparatus as claimed in claim 1, wherein said lighting unit of said lighting device further has a transparent cover member disposed on said circuit-mounting side of said heat sink and covering said light emitting diode.

8. The illumination apparatus as claimed in claim 1, wherein said light emitting diode of said lighting unit is attached on said circuit-mounting side of said heat sink using a heat-conductive glue.

9. The illumination apparatus as claimed in claim 8, wherein said heat-conductive glue includes a silver glue.

10. The illumination apparatus as claimed in claim 1, wherein said light emitting diode of said lighting unit has an outer surface coated with an fluorescence layer.

11. The illumination apparatus as claimed in claim 1, wherein said lighting device further includes a circuit board disposed fixedly on said circuit-mounting side of said heat sink and provided with said printed circuit thereon, said circuit board being formed with a through hole for receiving said light emitting diode of said lighting unit therein such that said light emitting diode of said lighting unit is attached directly on said heat-conductive insulating film.

12. The illumination apparatus as claimed in claim 1, wherein said light emitting diode of said lighting unit of said lighting device is formed with at least one lampwick.
